(19) United States
(12) Patent Application Publication
(10) Pub. No.: US 2014/0379833 A1
(43) Pub. Date: Dec. 25, 2014

(54) Server, Electronic Apparatus, Control Method of Electronic Apparatus, and Control Program of Electronic Apparatus

(71) Applicant: Kabushiki Kaisha Toshiba, Tokyo (JP)

(72) Inventor: Tsukasa Nunami, Ome-shi (JP)

(73) Assignee: KABUSHIKI KAISHA TOSHIBA, Tokyo (JP)

(21) Appl. No.: 14/180,232

(22) Filed: Feb. 13, 2014

(30) Foreign Application Priority Data
Jun. 20, 2013 (JP) JP 2013-130023

(51) Int. Cl. H04L 29/08; H04L 12/801

(52) U.S. Cl. CPC H04L 67/1097; H04L 47/12
USPC 709/212

(57) ABSTRACT

One embodiment provides a server including: a retriever configured to access a memory of each of plural electronic apparatuses to thereby retrieve status information of a prescribed device of each of the plural electronic apparatuses, the status information having been determined by the electronic apparatus and stored into the memory; a detector configured to detect which of a first status, a second status, and a third status the retrieved status information indicates; and a processor configured to perform first backup processing for the prescribed device if the detector detects that the status information indicates the second status, and to perform second backup processing for the prescribed device if the detector detects that the status information indicates the third status, the second backup processing being heavier in a server load than the first backup processing.

### CROSS-REFERENCE TO RELATED APPLICATION(S)

This application claims priority (priorities) from Japanese Patent Application No. 2013-130023 filed on Jun. 20, 2013, the entire contents of which are incorporated herein by reference.

### FIELD

Embodiments described herein relate generally to a server, an electronic apparatus, a control method of an electronic apparatus, and a control program of an electronic apparatus.

### BACKGROUND

In recent years, servers and such electronic apparatus (clients) as personal computers (PCs) have come into wide use and backup data of such electronic apparatus have come to be accumulated in servers.

For example, in some systems, when electronic apparatus that are unduly large in number for the processing ability of a server are connected to the server, a heavy load may be imposed on the server.

It is desired to reduce the load of a server in accumulating backup data of electronic apparatus in the server.

### BRIEF DESCRIPTION OF DRAWINGS

A general architecture that implements the various features of the present invention will now be described with reference to the drawings. The drawings and the associated descriptions are provided to illustrate embodiments and not to limit the scope of the present invention.

FIGS. 1A-1C illustrate a server and electronic apparatus (clients) according to an embodiment.

FIG. 2 shows an appearance of an example electronic apparatus according to the embodiment.

FIG. 3 is a block diagram showing the configuration of an example electronic apparatus according to the embodiment.

FIG. 4 is a sequence diagram showing how the server and each electronic apparatus (client) according to the embodiment operate.

FIG. 5 is a flowchart of a process that each electronic apparatus (client) according to the embodiment determines a status of a prescribed device (e.g., HDD) of its own.

FIG. 6 is a flowchart of a process that the server according to the embodiment performs backup processing according to information stored in a memory of each electronic apparatus (client) and indicating a status of a prescribed device (e.g., HDD) of the electronic apparatus.

### DETAILED DESCRIPTION

One embodiment provides a server including: a retriever configured to access a memory of each of plural electronic apparatuses to thereby retrieve status information of a prescribed device of each of the plural electronic apparatuses, the status information having been determined by the electronic apparatus and stored into the memory; a detector configured to detect which of a first status, a second status, and a third status the retrieved status information indicates; and a processor configured to perform first backup processing for the prescribed device if the detector detects that the status information indicates the second status, and to perform second backup processing for the prescribed device if the detector detects that the status information indicates the third status, the second backup processing being heavier in a server load than the first backup processing.

An embodiment will be hereinafter described with reference to the drawings.

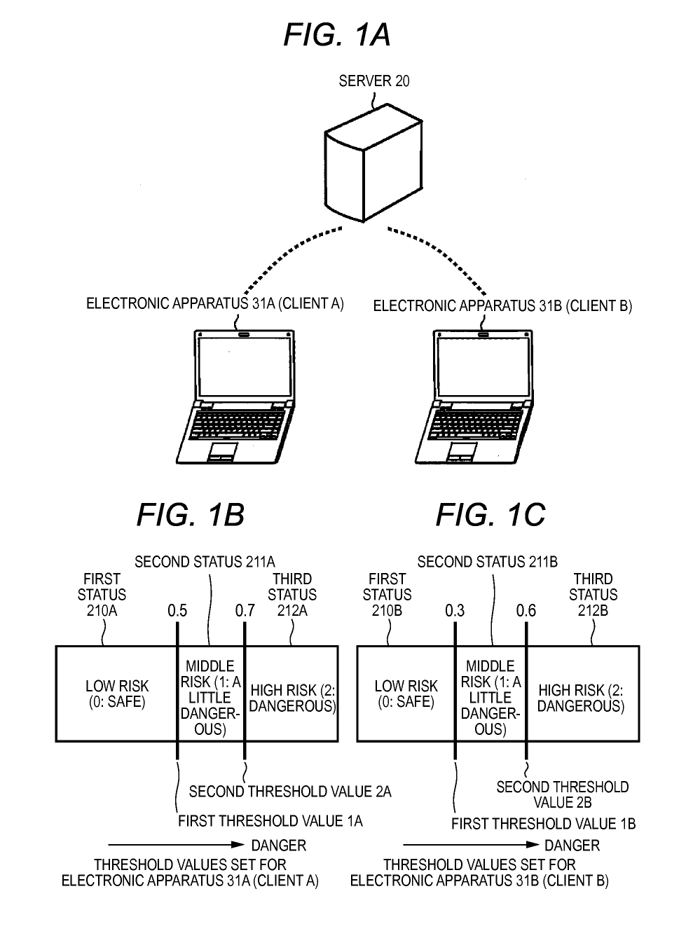

FIGS. 1A-1C illustrate a server and electronic apparatus (clients) according to the embodiment.

As show in FIG. 1A, plural electronic apparatuses (e.g., electronic apparatus 31A (client A) and electronic apparatus 31B (client B)) are connected to a server 20 (communications are performed between them).

The server 20 can store backup data of the plural electronic apparatuses.

In the embodiment, threshold values relating to the probability of occurrence of a failure in a prescribed device (e.g., HDD) of each electronic apparatus are set on the side of a manager (server 20). And each electronic apparatus determines a status of its own using the threshold value that is set for it.

Although the embodiment is directed to the case that the prescribed device of each electronic apparatus is an HDD, it is not limited to an HDD and may be an SSD, a semiconductor memory, or a like device.

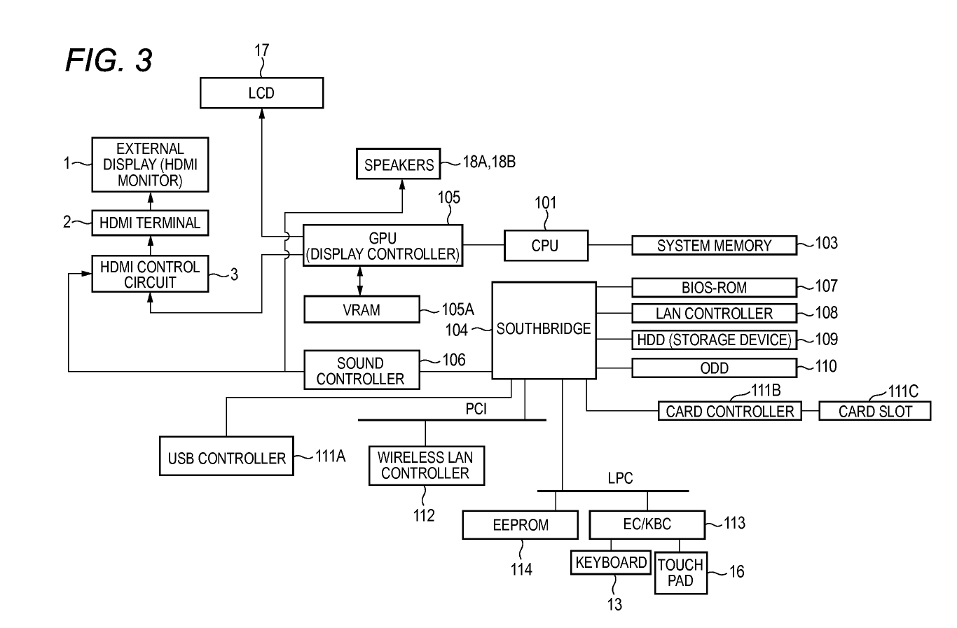

The above-mentioned threshold value is stored in an EEPROM 114 (see FIG. 3), for example.

In the embodiment, for example, the manager (server 20) causes an electronic apparatus that is higher in the probability of occurrence of a failure to be backed up preferentially among electronic apparatus in the same status.

In the embodiment, the server 20 is configured so as to be able to set plural threshold values for each of the plural electronic apparatuses connected to it and to change the thus-set threshold values arbitrarily.

In each electronic apparatus (e.g., electronic apparatus 31A (client A)), the threshold values are used in determining a status, relating to a probability of occurrence of a failure, of its own device (e.g., HDD 109 (see FIG. 3)) from among three statuses, that is, a first status (low risk or safe: 0), a second status (middle risk or a little dangerous: 1), and a third status (high risk or dangerous: 2).

FIG. 1B shows example threshold values that have been set for the electronic apparatus 31A (client A) by the server 20 (or later changed threshold values).

In this example, two threshold values, that is, a first threshold value 1A and a second threshold value 2A, are set at 0.5 and 0.7, respectively.

FIG. 1A means that the probability of occurrence of a failure of the HDD 109, for example, is low (data stored therein in relatively high in safety) in a left-side region.

FIG. 1A also means that the probability of occurrence of a failure increases (i.e., the degree of safety lowers (the danger increases)) as the position goes rightward.

A CPU 101 of the electronic apparatus 31A (client A) determines a status of its own prescribed device (e.g., HDD 109) using the first threshold value 1A (probability of occurrence of a failure: 0.5) and the second threshold value 2A (probability of occurrence of a failure: 0.7).

In the example of FIG. 1B, if the probability of occurrence of a failure of the HDD 109 is lower than the first threshold value 1A (probability of occurrence of a failure: 0.5), the status of the HDD 109 is judged to be a first status 210A.

If the probability of occurrence of a failure of the HDD 109 is higher than or equal to the first threshold value 1A (probability of occurrence of a failure: 0.5) and lower than the second threshold value 2A (probability of occurrence of a failure: 0.7), the status of the HDD 109 is judged to be a second status 211A.

If the probability of occurrence of a failure of the HDD 109 is higher than or equal to the second threshold value 2A (probability of occurrence of a failure: 0.7), the status of the HDD 109 is judged to be a third status 212A.

The first status 210A means “low risk” or “safe” and an identification value “0,” for example, is stored in the EEPROM 114 as corresponding to it. The second status 211A means “middle risk” or “a little dangerous” and an identification value “1,” for example, is stored in the EEPROM 114 as corresponding to it. The third status 212A means “high risk” or “dangerous” and an identification value “2,” for example, is stored in the EEPROM 114 as corresponding to it.

Likewise, FIG. 1C shows example threshold values that have been set for the electronic apparatus 31B (client B) by the server 20 (or later changed threshold values).

In this example, two threshold values, that is, a first threshold value 1B and a second threshold value 2B, are set at 0.3 and 0.6, respectively.

In the example of FIG. 1C, if the probability of occurrence of a failure of the HDD 109 is lower than the first threshold value 1B (probability of occurrence of a failure: 0.3), the status of the HDD 109 is judged to be a first status 210B.

If the probability of occurrence of a failure of the HDD 109 is higher than or equal to the first threshold value 1B (probability of occurrence of a failure: 0.3) and lower than the second threshold value 2B (probability of occurrence of a failure: 0.6), the status of the HDD 109 is judged to be a second status 211B.

If the probability of occurrence of a failure of the HDD 109 is higher than or equal to the second threshold value 2B (probability of occurrence of a failure: 0.6), the status of the HDD 109 is judged to be a third status 212B.

The first status 210B means “low risk” or “safe” and an identification value “0,” for example, is stored in the EEPROM 114 as corresponding to it. The second status 211B means “middle risk” or “a little dangerous” and an identification value “1,” for example, is stored in the EEPROM 114 as corresponding to it. The third status 212B means “high risk” or “dangerous” and an identification value “2,” for example, is stored in the EEPROM 114 as corresponding to it.

In the embodiment, the server 20 is equipped with a retriever which retrieves status information of a prescribed device (e.g., HDD 109 (see FIG. 3)) of an electronic apparatus (e.g., electronic apparatus 31A (client A)) that has been determined by the electronic apparatus and is stored in a memory (e.g., EEPROM 114 (see FIG. 3)) of the electronic apparatus by accessing the memory.

The server 20 is also equipped with a detector which detects which of three statuses (e.g., first status 210A, second status 211A, and third status 212A) the status information indicates.

The server 20 is also equipped with a processor which performs first backup processing for the prescribed device (e.g., HDD 109) if the detector detects that the status information indicates, for example, the second status 211A, and performs, for the prescribed device, second backup processing which is heavier in server load than the first backup processing if the detector detects that the status information indicates, for example, the third status 212A.

Each electronic apparatus (e.g., electronic apparatus 31A (client A)) according to the embodiment is equipped with a determinator which determines a status of a prescribed device (e.g., HDD 109) of its own from among three statuses (first status, second status, and third status) using, for example, a first threshold value 1A and a second threshold value 2A that have been set by the server 20.

Each electronic apparatus is also equipped with a memory (e.g., EEPROM 114) which stores the thus determined status of the prescribed device.

For example, the server 20 compares the threshold values (first threshold value 1A (probability of occurrence of a failure: 0.5) and second threshold value 2A (probability of occurrence of a failure: 0.7)) of the electronic apparatus 31A (client A) and the threshold values (first threshold value 1B (probability of occurrence of a failure: 0.3) and second threshold value 1B (probability of occurrence of a failure: 0.6)) of the electronic apparatus 31B (client B).

Back up is performed preferentially for the prescribed device of the electronic apparatus 31B for which the threshold values 0.3 and 0.6 are set over the prescribed device of the electronic apparatus 31A for which the threshold values 0.5 and 0.7 are set.

As described above, the server 20 (manager) sets priority ranks for the respective electronic apparatus (clients) by setting, for each electronic apparatus, threshold values relating to the probability of occurrence of a failure. And backup targets, for example, are narrowed down to electronic apparatus having higher priority ranks, the load of the server 20 can be lowered.

For example, estimation of a probability of occurrence of a failure (prediction of a time of occurrence of a failure) in the prescribed device (e.g., HDD 109) is done by regularly collecting variations in the number of bad sectors and other information using SMART information (information that is issued by the HDD itself and indicates its health; frequencies of occurrence of various kinds of errors that have occurred so far, a record of a worst one among errors that have occurred so far, and other information are stored in the HDD).

The above-mentioned estimation may be performed by the server 20 or the electronic apparatus 31A.

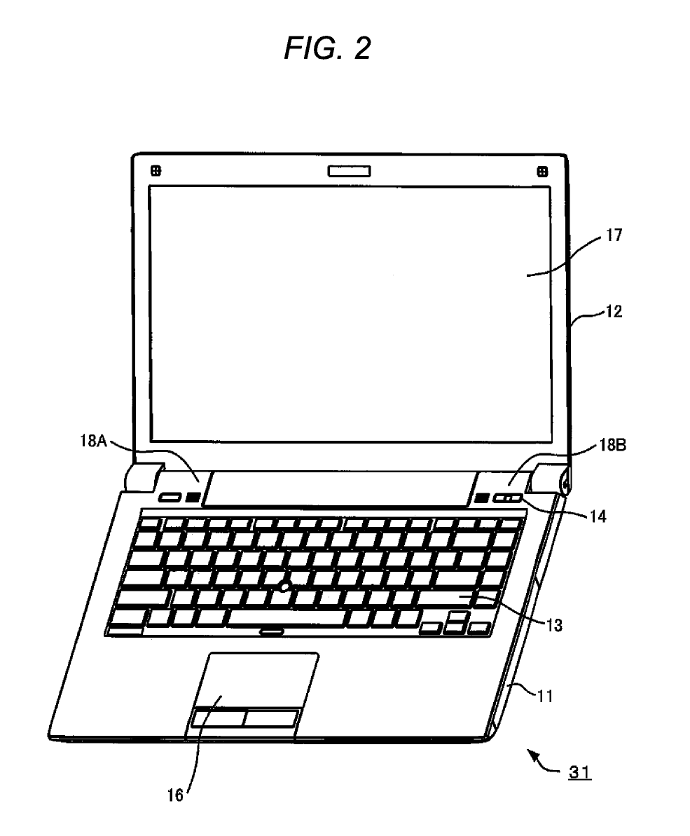

FIG. 2 shows an appearance of an example electronic apparatus (client) according to the embodiment.

The electronic apparatus 31 is a notebook personal computer (PC).

However, the concept of the embodiment can be applied to not only notebook PCs but also TV receivers, various portable electronic apparatus such as cellphones, smartphones, and tablet PCs, etc.

As shown in FIG. 2, the electronic apparatus 31 is composed of a computer main body 11 and a display device 12. The display device 12 incorporates an LCD (liquid crystal display) 17, for example.

The display device 12 is attached to the computer main body 11 so as to be rotatable between an open position where the display device 12 exposes the top surface of the computer main body 11 and a closed position where the display device 12 covers the top surface of the computer main body 11.

The computer main body 11 has a thin, box-shaped cabinet, and a keyboard 13, a power button 14 for powering on/off the electronic apparatus 31, a touch pad 16, speakers 18A and 18B, etc. are arranged on the top surface of the computer main body 11.

The right side surface, for example, of the computer main body 11 is provided with a USB (universal serial bus) connector (not shown) for connection of a USB cable or USB device of the USB 2.0 standard.

The back surface of the computer main body 11 is provided with an external display connection terminal (not shown) which complies with the HDMI (registered trademark) standard, for example. The external display connection terminal is used for outputting a digital video signal to an external display.

FIG. 3 is a block diagram showing the configuration of an example electronic apparatus (client) according to the embodiment.

As shown in FIG. 3, the electronic apparatus 31 is equipped with a CPU (central processing unit) 101, a system memory 103, a southbridge 104, a GPU (graphics processing unit) 105, a VRAM (video random access memory) 105A, a sound controller 106, a BIOS-ROM (basic input/output system-read only memory) 107, a LAN (local area network) controller 108, a hard disk drive (HDD; storage device) 109, an optical disc drive (ODD) 110, a USB controller 111A, a card controller 111B, a card slot 111C, a wireless LAN controller 112, an embedded controller/keyboard controller (EC/KBC) 113, an EEPROM (electrically erasable programmable ROM) 114, etc.

The CPU 101 controls the operations of the individual components of the electronic apparatus 31.

The CPU 101 runs a BIOS which is stored in the BIOS-ROM 107. The BIOS is programs for hardware control. The CPU 101 incorporates a memory controller for access-controlling the system memory 103. The CPU 101 also has a function of communicating with the GPU 105 via, for example, a serial bus of the PCI Express standard.

The GPU 105 is a display controller for controlling the LCD 17 which is used as a display monitor of the electronic apparatus 31.

A display signal generated by the GPU 105 is supplied to the LCD 17. The GPU 105 can also send a digital video signal to an external display 1 via an HDMI control circuit 3 and an HDMI terminal 2

The HDMI terminal 2 is the above-mentioned external display connection terminal. The HDMI terminal 2 makes it possible to send a non-compressed digital video signal and digital audio signal to the external display 1 such as a TV receiver via a single cable. The HDMI control circuit 3 is an interface for sending a digital video signal to the external display 1 (called an HDMI monitor) via the HDMI terminal 2.

The southbridge 104 controls individual devices on a PCI (peripheral component interconnect) bus and an LPC (low pin count) bus. The southbridge 104 incorporates an IDE (integrated drive electronics) controller for controlling the HDD 109 and the ODD 110.

The southbridge 104 also has a function of communicating with the sound controller 106.

The sound controller 106, which is a sound source device, outputs reproduction subject audio data to the speakers 18A and 18B or the HDMI control circuit 3. The LAN controller 108 is a wired communication device for performing a wired communication of the IEEE 802.3 standard, for example. On the other hand, the wireless LAN controller 112 is a wireless communication device for performing a wireless communication of the IEEE 802.11g standard, for example. The USB controller 111A communicates with an external device that complies with the USB 2.0 standard, for example.

For example, the USB controller 111A is used for receiving an image data file that is stored in a digital camera. The card controller 111B writes and reads data to and from a memory card such as an SD card that is inserted in the card slot 111C which is provided in the computer main body 11.

The EC/KBC 113 is a one-chip microcomputer in which an embedded controller for power management and a keyboard controller for controlling the keyboard 13 and the touch pad 16 are integrated together. The EC/KBC 113 has a function of powering on/off the electronic apparatus 31 in response to a user manipulation of the power button 14.

In the embodiment, for example, a display control is performed when the CPU 101 causes execution of programs stored in the system memory 103, the HDD 109, or the like.

Again, although a notebook personal computer (PC) has been exemplified as the electronic apparatus 31, the concept of the embodiment can be applied to not only notebook PCs but also TV receivers, various portable electronic apparatus such as cellphones, smartphones, and tablet PCs, etc.

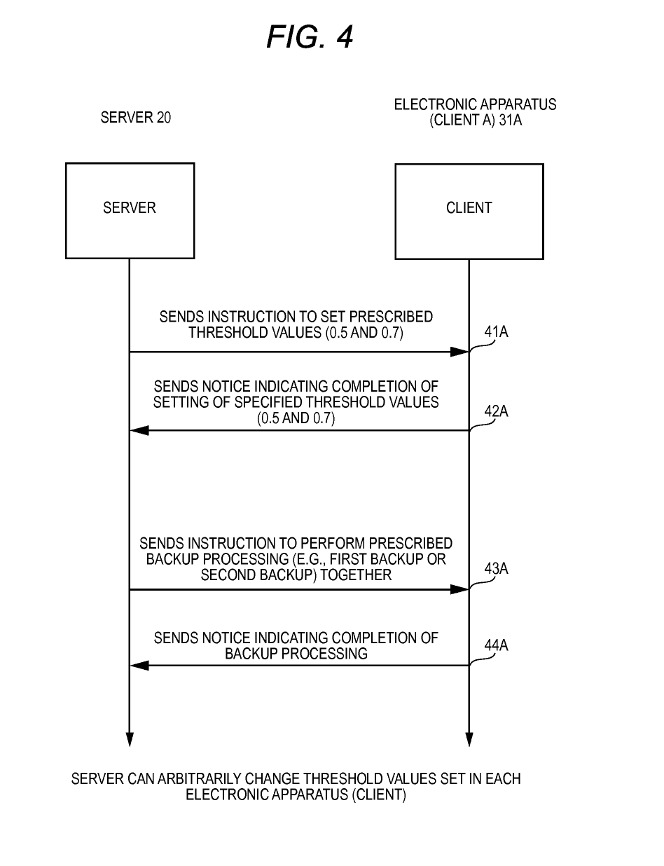

FIG. 4 is a sequence diagram showing how the server 20 and each electronic apparatus (client) according to the embodiment operate.

As mentioned above, the server 20 is connected to the plural electronic apparatuses (clients). The following description will be directed to a case that the server 30 and the electronic apparatus 31A (client A) operate together.

At step 41A, the server 20 accesses the electronic apparatus 31A and instructs it to set prescribed threshold values, that is, a first threshold value 1A (0.5) and a second threshold value 2A (0.7) which indicate probabilities of occurrence of a failure.

Here, it is assumed that the first threshold value 1A is 0.5, and the second threshold value 2A is 0.7.

At step 42A, the electronic apparatus 31A sets the specified threshold values (0.5 and 0.7) in itself and notifies the server 20 of completion of the setting.

In the embodiment, the server 20 is configured so as to be able to change the threshold values to be set in each electronic apparatus (e.g., electronic apparatus 31A) arbitrarily as appropriate.

At step 43A, the server 20 instructs the electronic apparatus 31A to perform prescribed backup processing (e.g., first backup or second backup (described later)) together.

At step 44A, the electronic apparatus 31A notifies the server 20 of completion of the prescribed backup processing.

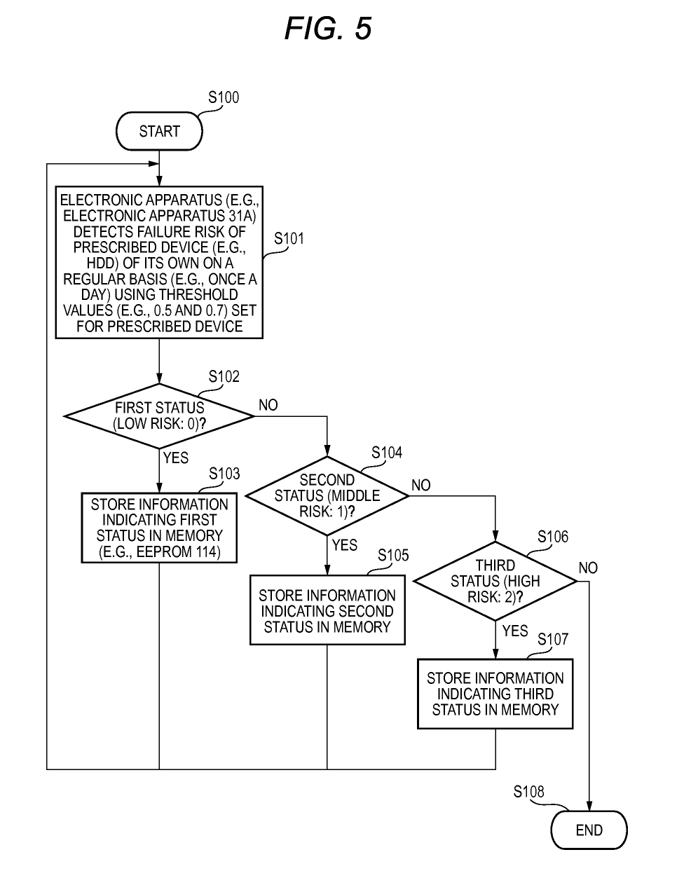

FIG. 5 is a flowchart of a process that each electronic apparatus (client) according to the embodiment determines a status of a prescribed device (e.g., HDD 109) of its own.

The process starts at step S100.

At step S101, the CPU 101 of the electronic apparatus (e.g., electronic apparatus 31A) detects a failure risk of a prescribed device (e.g., HDD) of its own on a regular basis (e.g., once a day) using threshold values (e.g., 0.5 and 0.7) set for the prescribed device.

At step S102, the CPU 101 judges whether or not the detected failure risk of the prescribed device is in a first status (low risk: 0). If it is judged that the failure risk is in the first status (S102: yes), the process moves to step S103. If it is judged that the failure risk is not in the first status (S102: no), the process moves to step S104.

At step S103, the CPU 101 stores information indicating the first status (low risk: 0) in the memory (e.g., EEPROM 114). The process then returns to step S101.

At step S104, the CPU 101 judges whether or not the detected failure risk of the prescribed device is in a second status (middle risk: 1). If it is judged that the failure risk is in the second status (S104: yes), the process moves to step S105. If it is judged that the failure risk is not in the second status (S104: no), the process moves to step S106.

At step S105, the CPU 101 stores information indicating the second status (middle risk: 1) in the memory. The process then returns to step S101.

At step S106, the CPU 101 judges whether or not the detected failure risk of the prescribed device is in a third status (high risk: 2). If it is judged that the failure risk is in the third status (S106: yes), the process moves to step S107. If it is judged that the failure risk is not in the third status (S106: no), the process moves to step S108.

At step S107, the CPU 101 stores information indicating the third status (high risk: 2) in the memory. The process then returns to step S101.

The process is finished at step S108.

Alternatively, the process may return to step S101 if it is judged that the failure risk of the prescribed device is not in the third status (S106: no)

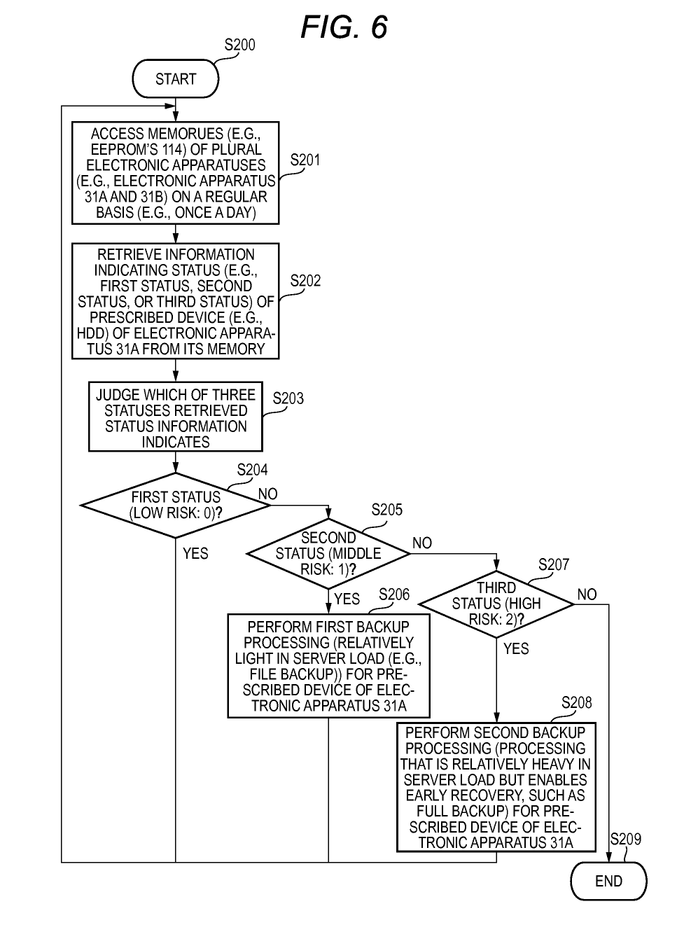

FIG. 6 is a flowchart of a process that the server 20 according to the embodiment performs backup processing according to information stored in the memory of each electronic apparatus (client) and indicating a status of a prescribed device (e.g., HDD 109) of the electronic apparatus.

The process starts at step S200.

At step S201, the server 20 accesses the memories (e.g., EEPROMs 114) of the plural electronic apparatuses (e.g., electronic apparatus 31A and 31B) on a regular basis (e.g., once a day). Although the following description will be directed to an exemplary case that the server 20 accesses the electronic apparatus 31A, the process remains the same also in the case of any of the other electronic apparatus.

At step S202, the server 20 retrieves information indicating a status (e.g., first status, second status, or third status) of a prescribed device (e.g., HDD 109) of the electronic apparatus 31A from its memory.

At step S203, the server 20 judges which of the three statuses the retrieved status information indicates.

At step S204, the server 20 judges whether or not the status of the prescribed device is the first status (low risk: 0). If it is judged that the status is the first status (S204: yes), the process returns to step S201. If not, the process moves to step S205.

At step S205, the server 20 judges whether or not the status of the prescribed device is the second status (middle risk: 1). If it is judged that the status is the second status (S205: yes), the process moves to step S206. If not, the process moves to step S207.

At step S206, first backup processing is performed for the prescribed device of the electronic apparatus 31A.

Then, the process returns to step S201.

For example, the first backup processing is processing that is relatively light in server load, such as file backup.

At step S207, the server 20 judges whether or not the status of the prescribed device is the third status (high risk: 2). If it is judged that the status is the third status (S207: yes), the process moves to step S208. If not, the process moves to step S209.

At step S208, second backup processing is performed for the prescribed device of the electronic apparatus 31A.

For example, the second backup processing is processing that is relatively heavy in server load but enables early recovery, such as full backup.

Then, the process returns to step S201.

The process finishes at step S209.

Next, a description will be described of the above-mentioned file backup and full backup.

The file backup is backup processing which is performed via a file system. The file backup is performed on a file or a folder.

The file backup has a feature that incremental backup and decremental backup can be realized easily because time stamps of a file system can be used.

It is said that in many cases recovery work requires a long procedure because, for example, it is desirable that a file system be constructed (or recovered earlier) at a recovery destination.

That is, in general, the file backup has a tendency that backup processing is fast but recovery, for example, is relatively slow.

For example, the full backup is processing of copying data en bloc.

In the full backup, all data need to be copied each time. Therefore, backup tends to take long time and a data back destination needs to have a sufficient free capacity.

On the other hand, since copied data are concentrated, the full backup has a feature that by virtue of a short procedure recovery work is completed fast.

As described above, in the embodiment, the manager (server 20) can set unique threshold values relating to the probability of occurrence of a failure in, for example, a prescribed device (e.g., HDD) of each of plural electronic apparatuses (e.g., client A, client B, and client C).

This makes it possible to set different priority ranks relating to backup processing for (the prescribed devices of) the plural electronic apparatuses.

In performing backup processing, the server load can be reduced by narrowing down targets so that, for example, the prescribed devices of electronic apparatus that are given higher priority ranks are subjected to backup processing earlier.

In the embodiment, the server 20 can arbitrarily change the threshold values that are set uniquely for (the prescribed devices of) plural electronic apparatuses.

Thus, the server load can be controlled and arbitrarily reduced by substantially changing, for example, the above-mentioned priority ranks relating to backup processing.

In the embodiment, for example, plural threshold values can be set in such a manner that the first threshold value 1A and the second threshold value 2A of the electronic apparatus 31A (client A) to 0.5 and 0.7, respectively, and first threshold value 1B and the second threshold value 2B of the electronic apparatus 31B (client B) to 0.3 and 0.6, respectively (see FIGS. 1B and 1C).

Assume that the probabilities of occurrence of a failure of the prescribed devices of the electronic apparatus 31A and the electronic apparatus 31B are judged to be in the second status 211A and the second status 211B, respectively, that is, in the same second status (middle risk).

However, between the electronic apparatus 31A and 31B in the same status, backup processing can be performed preferentially for the electronic apparatus 31B which is higher in the probability of occurrence of a failure.

This also contributes to reduction of the load of the server 20.

As described above, the embodiment makes it possible to lower the load of the server 20 by setting priority ranks for pieces of backup processing and perform them efficiently.

The server 20 according to the embodiment is equipped with a retriever for retrieving status information (information indicating a first status, a second status, or a third status) of a prescribed device (e.g., HDD 109) of each electronic apparatus (e.g., electronic apparatus 31A) that has been determined by the electronic apparatus and is stored in a memory (e.g., EEPROM 114) of the electronic apparatus by accessing the memory; a detector for detecting which of the first status, the second status, and the third status the retrieved status information indicates; and a processor for performing first backup processing for the prescribed device if the detector detects that the status information indicates the second status, and performing, for the prescribed device, second backup processing which is heavier in server load than the first backup processing if the detector detects that the status information indicates the third status.

The server 20 is configured so as to set, for each electronic apparatus, a first threshold value and a second threshold value to be used for determining status information, and to change the first threshold value and the second threshold value.

The retriever of the server 20 retrieves status information on a regular basis.

The prescribed device of each of electronic apparatus is an HDD.

Each electronic apparatus (e.g., electronic apparatus 31A) according to the embodiment is equipped with a determinator for determining a status of a prescribed device (e.g., HDD 109) of its own from among a first status, a second status, and a third status using a first threshold value and a second threshold value that have been set by the server 20; and a memory (e.g., EEPROM 114) for storing information indicating the determined status of the prescribed device.

The determinator of each electronic apparatus determines a status of the prescribed device on a regular basis.

The information indicating the determined status of the prescribed device stored in the memory is retrieved by the server 20.

With the above configurations, where backup data of plural electronic apparatuses (clients) are accumulated in the server 20, the embodiment makes it possible to lower the load of the server 20.

Every control process of the embodiment can be implemented by software. Therefore, the advantages of the embodiment can easily be obtained merely by installing programs of the control processes in an ordinary computer via a computer-readable storage medium that is stored with those programs and running the installed programs.

The invention is not limited to the above embodiment itself and, in the practice stage, may be embodied in such a manner that constituent elements are modified in various manners without departing from the spirit and scope of the invention.

Various inventive concepts may be conceived by properly combining plural constituent elements disclosed in the embodiment.

For example, several ones of the constituent elements of the embodiment may be omitted.

1. A server comprising:
a retriever configured to access a memory of each of plural electronic apparatuses to thereby retrieve status information of a prescribed device of each of the plural electronic apparatuses, the status information having been determined by the electronic apparatus and stored into the memory;
a detector configured to detect which of a first status, a second status, and a third status the retrieved status information indicates; and
a processor configured
to perform first backup processing for the prescribed device if the detector detects that the status information indicates the second status, and
to perform second backup processing for the prescribed device if the detector detects that the status information indicates the third status, the second backup processing being heavier in a server load than the first backup processing.

2. The server of claim 1,
wherein the server is configured to set a first threshold value and a second threshold value for each of the plural electronic apparatuses, the first threshold value and the second threshold value to be used for determining the status information of the prescribed device.

3. The server of claim 1,
wherein the retriever periodically retrieves the status information.

4. The server of claim 1,
wherein the prescribed device is an HDD.

5. An electronic apparatus comprising:
a determinator configured to determine a status of a prescribed device of the electronic apparatus from among a first status, a second status, and a third status using a first threshold value and a second threshold value, the first threshold value and the second threshold value having been set by a server; and
a memory configured to store information indicating the determined status of the prescribed device.

6. The apparatus of claim 5,
wherein the determinator periodically determines the status of the prescribed device.

7. The apparatus of claim 5,
wherein the memory allows the server to retrieve the stored information.

8. A method for controlling an electronic apparatus, the method comprising:
determining a status of a prescribed device of the electronic apparatus from among a first status, a second status, and a third status using a first threshold value and a second threshold value, the first threshold value and the second threshold value having been set by a server; and
storing information indicating the determined status of the prescribed device.

9. A program for controlling an electronic apparatus by causing the electronic apparatus to execute processing, the processing comprising:
determining a status of a prescribed device of the electronic apparatus from among a first status, a second status, and a third status using a first threshold value and a second threshold value, the first threshold value and the second threshold value having been set by a server; and
storing information indicating the determined status of the prescribed device.
